(19) United States
(12) Patent Application Publication
(10) Pub. No.: US 2009/0050341 A1
(43) Pub. Date: Feb. 26, 2009

(54) APPARATUS AND METHODS FOR LAND PREPARATION AND CLEARING

(75) Inventors: Daniel Hathaway, Baker, NV (US); Jeffrey Stanley, Lebanon, OH (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: FECON, INC., Lebanon, OH (US)

(21) Appl. No.: 12/172,691

(22) Filed: Jul. 14, 2008

Related U.S. Application Data
(63) Continuation of application No. PCT/US08/69770, filed on Jul. 11, 2008.
(60) Provisional application No. 60/949,693, filed on Jul. 13, 2007.

(51) Int. Cl. A01B 21/02; A01B 63/02

(52) U.S. Cl. 172/321; 172/548

(57) ABSTRACT

Embodiments of a land preparation apparatus comprises a chamber comprising at least one internal surface, and a plurality of internal rakes configured in a non-linear arrangement along the at least one internal surface. Further embodiments of a land preparation apparatus comprises a chamber comprising at least one internal surface, a rotatable tool rotatably mounted within the chamber and having a plurality of tool elements for land preparation, and a plurality of internal rakes configured in a non-linear arrangement along the at least one internal surface, wherein the rotatable tool moves the plurality of tool elements relative to the plurality of internal rakes. The land preparation apparatus may be removably or fixedly connected to a vehicle to form a land preparation machine.

### CROSS REFERENCE TO RELATED APPLICATIONS

This application is a Continuation of International Application No. PCT/US08/69770 filed Jul. 11, 2008, which claims the benefit of Provisional Application No. 60/949,693 filed Jul. 13, 2007.

### TECHNICAL FIELD

The present invention relates generally to attachment systems and methods for cutting, grinding, and mulching tools, and specifically relates to cutting rake configurations to be used in the mulching chamber of a mulching tool.

### BACKGROUND

Land preparation and clearing machines and apparatus such as forestry machines and apparatus are utilized for clearing land, creating paths, and otherwise removing debris, brush, trees, vegetation, soil, concrete, asphalt, rock, and/or other materials, making the land suitable for further development or use. To carry out these tasks, such machines can be fitted with land preparation attachments or apparatus operable to mulch, cut, shred, and/or grind vegetation, brush, trees, stumps, soil, concrete, asphalt, rock, and other materials.

In particular, the apparatus may be integrally or detachably attached to a tractor, skid steer, or other vehicle to facilitate articulation and movement of the mowing apparatus with respect to the vegetation. Often, the vehicle is a multi-purpose vehicle having the capability to be fitted with any of a variety of attachments suitable for the task at hand. For example, the vehicle can include a common connection for connecting to and driving the apparatus such as brush cutters, rotary mowers, shredders, grinders, and crushers. Such apparatus can be hydraulically driven via hydraulic power from the vehicle. One illustrative type of land preparation apparatus is known as a “flail mower” which utilizes a rotatable axle with either swinging or fixed position cutting tools (often known as “flails”).

Often, the land preparation apparatus comprises a mulching chamber used to grind up feed material, e.g. brush, vegetation, trees, etc. Conventional mulching chambers comprise a linear arrangement of rakes inside the chamber. Accordingly, improvements in forestry mulching devices and the components used therein are desired.

### SUMMARY

According to one embodiment of the present invention, a land preparation apparatus comprises a housing, a chamber formed within the housing, the chamber comprising at least one internal surface, and a plurality of internal rakes configured in a non-linear arrangement relative to the horizontal along the at least one internal surface and configured to assist in land preparation.

According to another embodiment, a land preparation apparatus comprises a chamber comprising at least one internal surface, a rotatable tool rotatably mounted within the chamber and having a plurality of tool elements for land preparation, and a plurality of internal rakes configured in a non-linear arrangement along the at least one internal surface, wherein the rotatable tool moves the plurality of tool elements relative to the plurality of internal rakes.

According to yet another embodiment, a mulching chamber comprises at least one internal surface, and a plurality of internal rakes configured in a non-linear arrangement along the at least one internal surface and configured to create mulch from feed material.

According to still yet another embodiment, a land preparation machine comprises a vehicle; a land preparation apparatus connectable to the vehicle, comprising a housing, a chamber formed within the housing, and first and second internal surfaces formed within the chamber, wherein the first surface is near an inlet for feed material, the second surface is near an outlet of the chamber, and the second surface is positioned such that it receives feed material after it passed along the first surface; and a plurality of internal rakes extending from the first and second internal surfaces and configured in a non-linear arrangement relative to a longitudinal axis of the land preparation apparatus.

These and additional objects and advantages provided by the embodiments of the present invention will be more fully understood in view of the following detailed description, in conjunction with the drawings.

### BRIEF DESCRIPTION OF DRAWINGS

The following detailed description of specific embodiments of the present invention can be best understood when read in conjunction with the drawings enclosed herewith. The drawing sheets include:

FIG. 1 is a top perspective view of an exemplary land clearing and preparation machine according to one or more embodiments of the present invention;

FIG. 2 is a perspective view of the exemplary land clearing and preparation machine of FIG. 1;

FIG. 3 is a front elevational view of an exemplary land preparation apparatus according to one or more embodiments of the present invention;

FIG. 4 is a cross sectional view taken along A-A of the exemplary land preparation apparatus of FIG. 3;

FIG. 5 is a perspective view of the exemplary rotatable tool connected within the exemplary land preparation tool of FIG. 3;

FIG. 6 is a front elevational view of the exemplary land preparation apparatus of FIG. 3 without the guard assembly and rotatable tool;

FIG. 7 is a left side perspective view of the exemplary land preparation apparatus of FIG. 6;

FIG. 8 is a cross sectional view taken along A-A of the exemplary land preparation apparatus of FIG. 6;

FIG. 9 is a front elevation view of another exemplary land preparation apparatus according to one or more embodiments of the present invention;

FIG. 10 is a cross section view taken along A-A of the exemplary land preparation apparatus of FIG. 9; and

FIG. 11 is a perspective view of the exemplary rotatable tool connected within the exemplary land preparation tool of FIG. 9.

The embodiments set forth in the drawings are illustrative in nature and not intended to be limiting of the invention defined by the claims. Moreover, individual features of the drawings and the invention will be more fully apparent and understood in view of the detailed description.

### DETAILED DESCRIPTION OF ILLUSTRATIVE EMBODIMENTS

The present invention is generally directed to land preparation and clearing machines (“Land Preparation Machine”) that are designed to cut, grind, mulch, shred clear, mill, and/or mix trees, brush, ground cover, vegetation, debris, asphalt, concrete, and/or soil. The Land Preparation Machines and their corresponding implements may comprise a variety of vehicles and implements, including but not limited to skid steer vehicles, forestry machines and vehicles, PTO tractors, farm tractors and/or any other known vehicles and their corresponding implements compatible with land preparation and clearing. Such Land Preparation Machines may prepare the surface of the earth and are not sub-surface machines used in mining operations. As used herein, the phrases “land preparation and clearing” and “land preparation” will mean any land preparation and clearing operations, including but not limited to forestry operations such as cutting, grinding, mulching, shredding, clearing, milling, and/or mixing trees, brush, ground cover, vegetation, debris, soil, rock, asphalt, concrete, and/or soil. However, such phrases do not mean any subsurface work such as mining, drilling, etc. As used herein, “feed material” describes trees, brush, ground cover, vegetation, debris, soil, rock, asphalt, concrete, and/or soil produced from such land preparation and clearing operations, including but not limited to forestry operations such as clearing land, cutting and/or mulching trees, and/or preparing land surfaces (e.g., creating paths).

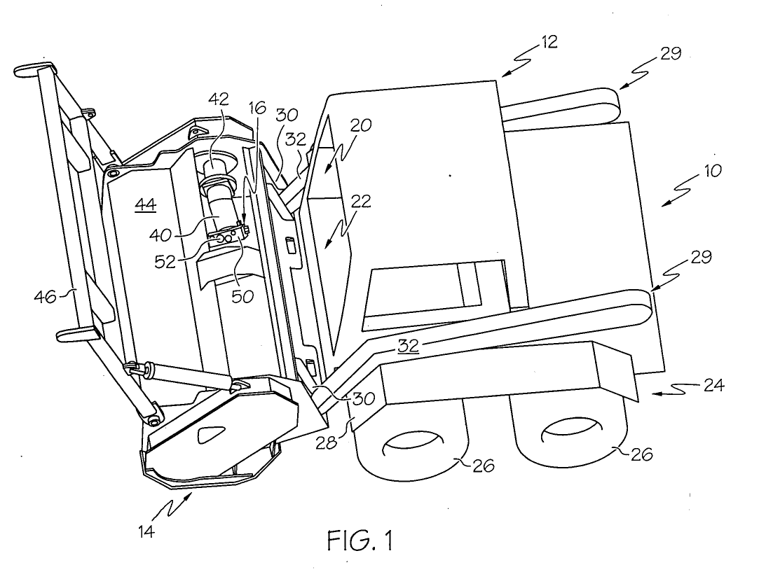

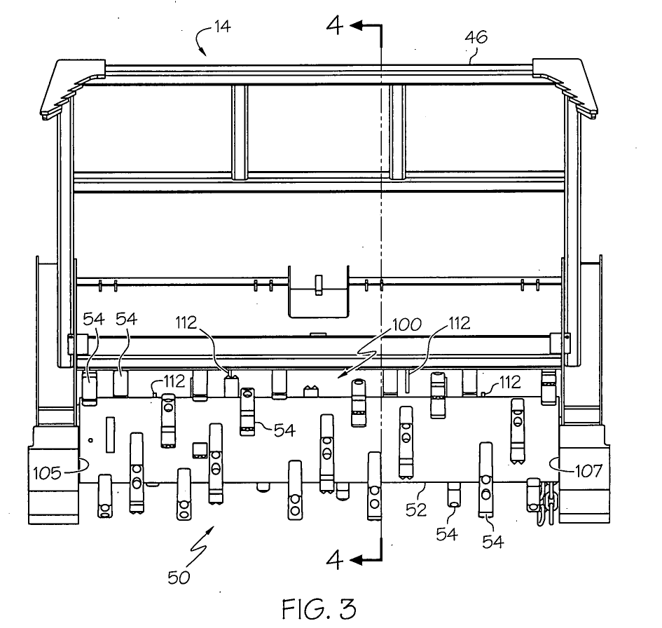

Referring to FIGS. 1-8 an exemplary embodiment of a Land Preparation Machine 10, including a vehicle 12 (e.g., a forestry vehicle) and a land preparation apparatus 14 connected to the vehicle 12, is shown. In this exemplary embodiment, the vehicle 12 is a skid steer vehicle suitable for off-road travel, and includes a driver station 20 as well as an all-terrain wheel assembly 24. The wheel assembly may include tires 26. In addition, tires 26 may drive all-terrain tracks (not shown), which may provide traction for the vehicle 12 to move over a variety of terrains and in a variety of conditions. The all terrain tracks may comprise metal or rubber-based tracks that wrap around tires 26 as known to one of ordinary skill in the art. The vehicle 12 also includes a hydraulically operated vertical lift assembly 29 for vertically lifting the land preparation apparatus 14, and any other attachments that may be used with the vehicle. Controls 22 can be provided for control of the hydraulic lift assembly 29, including the lift arms 32 as well as for controlling the power provided to the wheel assembly 24 and for controlling the operation of the land preparation apparatus 14.

While the land preparation apparatus 14 is shown in this example connected to and powered by vehicle 12 which is a skid steer vehicle, other suitable all-terrain vehicles with capability for powering and utilizing a hydraulic motor attachment or tool (e.g., such as land preparation apparatus 14) could be provided, such as other forestry vehicles, mini-track loaders, excavators, backhoes, PTO tractors, farm tractors, and/or any other known vehicles and their corresponding implements compatible with land preparation and clearing. Further examples of suitable skid steer vehicles are shown and described in U.S. Pat. No. 4,168,757 and 4,209,071, the entire disclosures of which are hereby incorporated by reference herein.

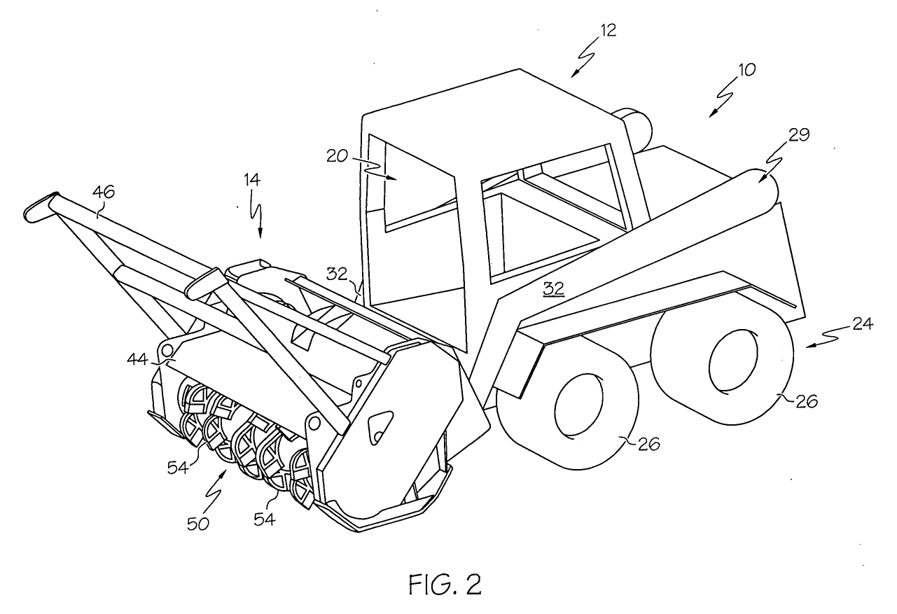

In the exemplary embodiment shown in FIGS. 1 and 2, the land preparation apparatus 14 is removably connectable to the vehicle 12. The connection between the attachment 14 and the vehicle 12 can be accomplished in any of a variety of manners, such as by providing receptacles 30 for receiving vertical lift arms 32 from the vehicle 12. The land preparation apparatus 14, in this example, further includes a hydraulic supply connection for receiving an operating supply of hydraulic fluid from a pump within the vehicle to power the land preparation apparatus 14, and a hydraulic return connection for returning hydraulic fluid to a tank within the vehicle 12. The hydraulic supply and return connections may comprise convention quick-disconnect connections as known to one of ordinary skill in the art.

It is understood that land preparation apparatus 14 may also be fixedly attached to the vehicle 12 and/or be a stand alone machine such as a walk behind land preparation apparatus. Also, it is understood that other hydraulically-operated rotary mowing or cutting attachments may be utilized with principles of the present invention, integral with or detachable from vehicle 12, and/or separately from or in combination with the land preparation apparatus 14. Other configurations are also possible, such as where the fluid pump and tank are located at other locations. Connection, powering, and movement of the land preparation apparatus 14 can be accomplished with various configurations, such as those described in U.S. Pat. Nos. 4,148,366, and 5,813,792, for example, which are hereby incorporated herein by reference.

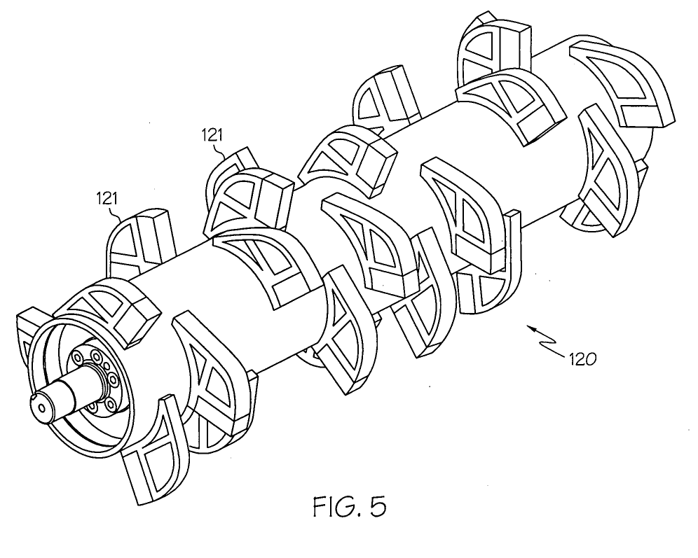

The land preparation apparatus 14 may include a housing 44 forming a chamber 100, right and left end plates 105 and 107, respectively, connected to the housing 44, and a movable tool (e.g., rotatable tool 50) movably (e.g., rotatably) connected to and between the right and left end plates 105 and 107 within the chamber 100. Right and left end plates 105 and 107 may alternatively be integral with the housing 44. In this exemplary embodiment, the rotatable tool 50 comprises a rotatable drum or rod 52 and a plurality of tool elements 54 spaced along and extending radially from the tool drum 52 as shown in FIGS. 2-5. For illustration and simplification purposes only, FIG. 5 shows rotatable tool 50 outside of housing 44.

Optionally, rotatable tool 50 may also comprise an axle 56 extending longitudinally from either one or both ends of the tool drum 52. For movement of the rotatable tool 50, a hydraulic motor 40, such as a hydraulic piston motor, provides rotation of a rotor (e.g., drive shaft 42) which drives the rotatable tool drum 52, which thereby causes rapid rotation of the tool elements 54, such as at speeds of between about 100 to about 3000 rpm. The drive shaft 42 may drive a belt (not shown), which engages and drives the axle 56 to turn tool drum 52. Alternatively, the drive shaft 42 may be directly connected to the drum 52 or axle 56.

In one particular embodiment, the hydraulic lift arms 32 raise and lower the land preparation apparatus 14 via controls 22 to allow the rotatable tool's rotating tool elements 54 (e.g., teeth or cutters) to come into contact with brush, trees, vegetation, or other objects to be cut or shredded or cleared. Controls 22 may also control the supply of fluid to the hydraulic motor 40 to start and stop the rotation of the tool drum 52 and tool elements 54.

In yet another exemplary embodiment, the hydraulic motor 40 is controlled by a hydraulic brake 16 which automatically slows the motor 40 when the flow of hydraulic fluid to the motor via the hydraulic supply line is discontinued. For additional detail on land preparation machinery (e.g., forestry machinery) or hydraulic components associated with land preparation machinery (e.g., forestry machinery), U.S. Publication No. 2006/0032222 has been incorporated by reference in its entirety herein.

Still referring to FIGS. 1-8, the rotatable tool 50, including the tool drum 52 and tool elements 54 may be formed in any of a number of suitable configurations, including but not limited to a plurality of spaced tool elements 54 disposed on one or more tool drums which may be mounted between end plates 105 and 107 of the land preparation apparatus 14. The tool elements 54 may be fixedly, removably, and/or rotatably mounted to tool drum 52. The tool elements 54 may comprise cutters, blades, grinders, chipper, knife, hammer elements, milling elements, flailing elements, and other tools for suitable for land surface preparation as described above herein. The tool elements 54 may be fabricated from a variety of metals, composites, plastics, or combinations thereof. The tool elements 54 may comprise integral or separate and replaceable tooling tips such as blades, which may be comprised of a carbide tip, steel tip, composite tip, combination thereof, or other materials for assistance with land surface preparation and clearing. Exemplary tool elements that may comprise the present invention include those tool elements described in U.S. Pat. No. 4,223,441 and U.S. Pat. No. 4,222,418, which are hereby incorporated by reference herein. The land preparation attachment 14 may include any number of suitable components, cutters, grinders, mixers, and/or tools for providing a cutting, grinding, mulching, shredding, clearing, milling, and/or mixing function. In addition, the land preparation apparatus may comprise safety mechanisms such as a guard assembly 46 as shown in FIGS. 1-4.

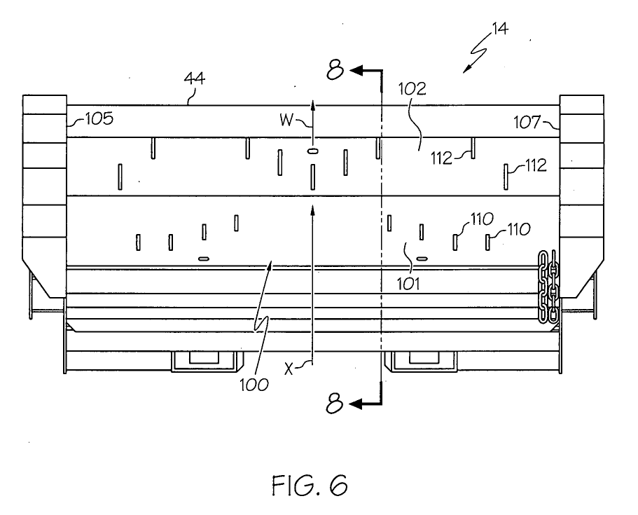

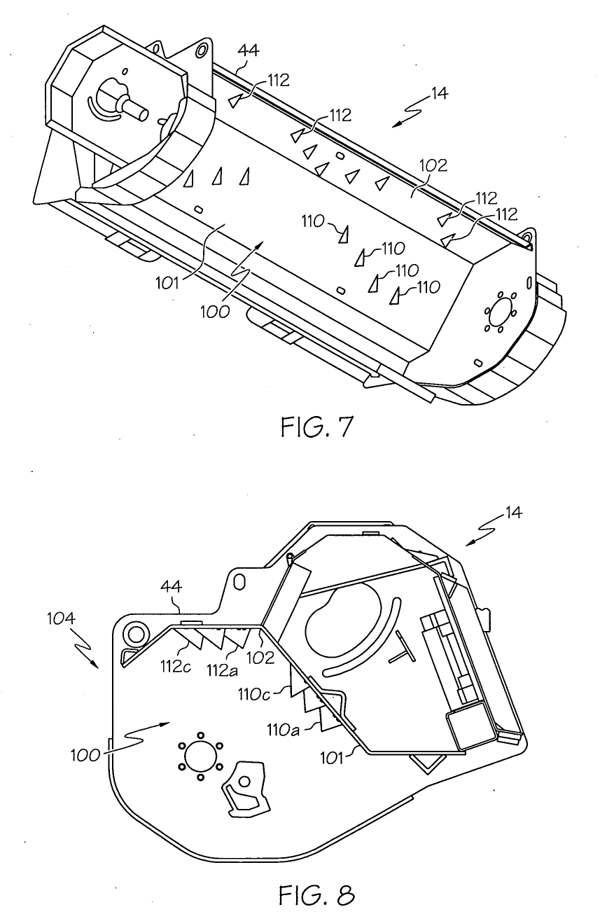

Referring to FIGS. 6-8, the exemplary land preparation apparatus 14 is shown without the guard assembly 46 and rotatable tool 50 for simplification and improved understanding of this exemplary embodiment. The land preparation apparatus' chamber 100 includes at least one internal surface. As shown, the exemplary chamber 100 includes a first internal surface 101 and a second internal surface 102. In this exemplary embodiment, the first internal surface 101 comprises a plurality of internal rakes 110, and the second internal surface 102 comprises a plurality of internal rakes 112. Referring to FIGS. 6-7, both the plurality of first and second internal rakes 110 and 112, respectively, are configured in a non-linear arrangement along their respective internal surfaces 101 and 102 relative to the horizontal along the first and second internal surfaces or relative to the longitudinal axis of the land preparation apparatus along the first and second internal surfaces.

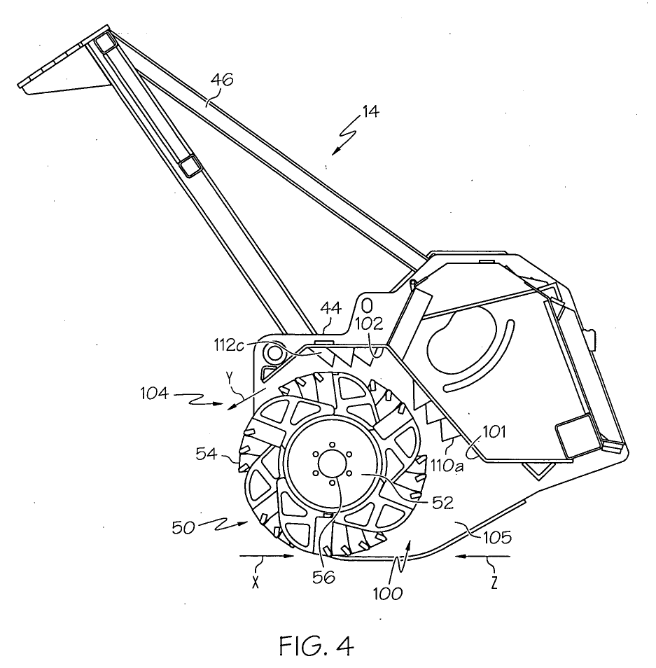

The chamber 100 is configured such that as material is fed into the chamber 100 (e.g., as represented by Arrow X), the first internal surface 101 may receive the feed material, which may pass along the first internal surface 101 and through its internal rakes 110, then pass along the second internal surface 102 and through its internal rakes 112, and finally exiting the chamber 100 at outlet 104 as represented by Arrow Y. FIG. 4 shows that the first and second internal surfaces 101 and 102 may be configured such that internal rake 110a is further away from the tool elements 54 of the tool drum 52 than internal rake 112c, and that the internal rakes may get progressively closer to the tool element 54 from internal rake 110a to 112c. As shown in FIGS. 4 and 8, the second internal surface 102 may be located near the outlet 104, wherein the mulch or ground feed material produced in the chamber 100 may be dispensed as represented by Arrow Y.

The first and second internal rakes 110 and 112, which may be stationary, may comprise any cutting implement suitable to break down feed material into smaller quantities as feed material moves the through the chamber and contacts the rakes (such as under a vacuum force caused by the high speed rotation of the rotor and cutting elements). The non-linear configuration of the stationary rakes 110 and 112 may define various rake arrangements on the inner surface of the mulching chamber 100. The non-linear configuration may at least partially define a stepped configuration (where adjacent rakes are located at higher or lower levels relative to one another), a funnel shaped configuration, a non-aligned configuration (such that the tops and bottoms of all rakes do not lined up relative to the horizontal direction of the surface), a substantially V-shaped configuration (where adjacent rakes form a generally V shape), a substantially inverted V-shaped configuration, an inwardly tapering configuration, or combinations thereof.

Referring to FIGS. 6-7, using such configurations, the material may funnel inwardly towards the center rakes along first surface 101 and in the direction labeled as X and then funnel outwardly along second surface 102 in the direction labeled W toward the outward rakes to direct the material flow at a higher rate of velocity throughout the entire mulching chamber. Other non-linear configurations are also contemplated herein, including but not limited to staggered rows, inverted V shaped, and other non-linear configurations.

It is found that the non-linear configuration of internal rakes can increase the velocity of the feed material inside the mulching chamber as compared to conventional mulching chambers with a linear configuration of internal rakes. The increased velocity provides improved separation of the feed material inside the mulching chamber. Due in part to the increased material velocity and increased separation, the power requirements of the land preparation apparatus 14 and thereby the power requirements of the Land Preparation Machine can be reduced.

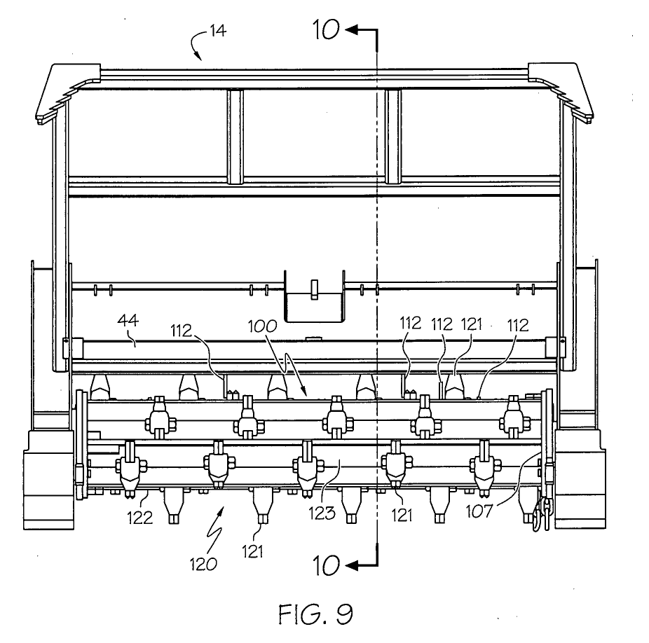

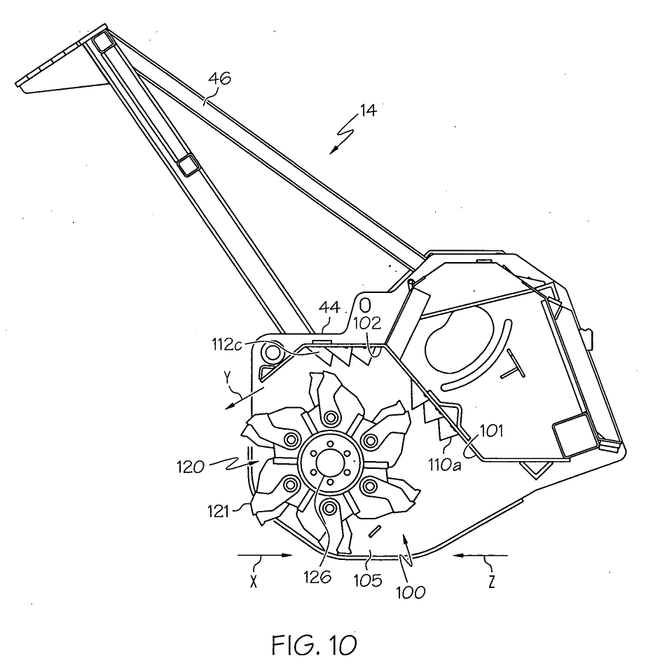

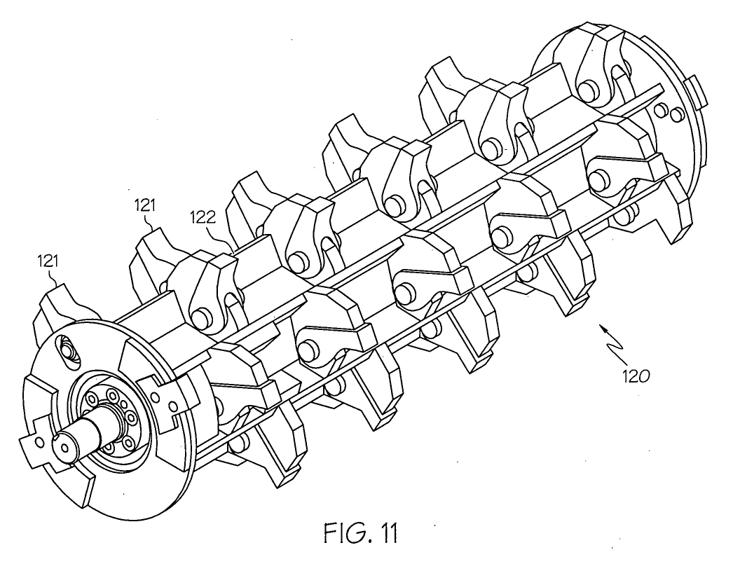

Referring to FIGS. 9-11, an alternative embodiment of land preparation apparatus 14 is shown, wherein apparatus 14 comprises all the same and/or similar components as the exemplary land preparation apparatus described and shown above, which is herein incorporated by reference. The only difference in this embodiment is that the land preparation apparatus 14 comprises a different movable tool. In this embodiment, movable tool comprises rotatable tool 120, which comprises a cylindrical body 123, paddles 122 extending longitudinally along and extending radially from the body 123, and tool elements 121 extending radially from the body 123 and positioned longitudinally along and circumferentially around the body 123. For illustration and simplification purposes only, FIG. 11 shows rotatable tool 120 outside of housing 44. The paddles 122 and the tool elements 121 are dimensioned and configured to transport feed material to the and through the chamber 100 and to grind, cut, and/or mulch the feed material. It is contemplated that the rotatable tool 120 may only comprise paddles 122.

In operation, the rotatable tool 120 may grind, cut, and/or mulch the feed material with its tool elements 121 while the paddles 122 may move or assist in moving the feed material to and through the chamber 100. Upon entering the chamber 100, the material contacts the tines or rakes 110 and 112 arranged in the non-linear configuration. Since the internal rakes are not arranged linearly as in previous embodiments, the material is able to increase its velocity by not being contacted all at once by a linear row of rakes. The increased velocity improves the land preparation process (e.g., mulching/cutting process). The mulch, which is produced, is then delivered out of the mulching chamber 100.

It is noted that terms like “specifically,” “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention. It is also noted that terms like “substantially” and “about” are utilized herein to represent the inherent degree of uncertainty that may be attributed to any quantitative comparison, value, measurement, or other representation.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A land preparation apparatus, comprising:
a housing;
a chamber formed within the housing, the chamber comprising at least one internal surface; and
a plurality of internal rakes configured in a non-linear arrangement relative to the horizontal along the at least one internal surface and configured to assist in land preparation.

2. The apparatus as recited in claim 1, wherein the plurality of internal rakes define at least partially a stepped configuration relative to the horizontal direction on the at least one internal surface.

3. The apparatus as recited in claim 1, wherein the plurality of internal rakes define at least partially a funnel shaped configuration on the at least one internal surface.

4. The apparatus as recited in claim 1, wherein the plurality of internal rakes defines at least partially a substantially V-shaped configuration on the at least one internal surface.

5. The apparatus as recited in claim 1, wherein the plurality of internal rakes defines at least partially a substantially inverted V-shaped configuration on the at least one internal surface.

6. The apparatus as recited in claim 1, wherein the plurality of internal rakes defines at least partially an inwardly tapering configuration on the at least one internal surface.

7. The apparatus as recited in claim 1, wherein the plurality of internal rakes is stationary on the at least one internal surface.

8. The apparatus as recited in claim 1, wherein the non-linear configuration of internal rakes is operable to increase the velocity of the feed material inside the chamber as compared to the velocity of feed material inside a chamber with a linear configuration of internal rakes.

9. The apparatus as recited in claim 8, wherein the increased velocity of feed material is configured to provide improved separation of the feed material inside the chamber.

10. The apparatus as recited in claim 1, wherein the non-linear configuration of internal rakes is operable to reduce the power requirements of the land preparation apparatus as compared to the power requirements of a land preparation apparatus having a linear configuration of internal rakes.

11. The apparatus as recited in claim 1, further comprising a movable tool moveably mounted within the chamber, wherein the tool comprises at least one tool element for land preparation.

12. A vehicle comprising the land preparation apparatus of claim 1.

13. A land preparation apparatus, comprising:
a chamber comprising at least one internal surface;
a rotatable tool rotatably mounted within the chamber and having a plurality of tool elements for land preparation; and
a plurality of internal rakes configured in a non-linear arrangement along the at least one internal surface,
wherein the rotatable tool moves the plurality of tool elements relative to the plurality of internal rakes.

14. The apparatus as recited in claim 13, wherein the rotatable tool comprises paddles operable to deliver feed material to and move feed material through the chamber.

15. The apparatus as recited in claim 13, wherein the at least one internal surface comprises a first internal surface having a plurality of first internal rakes, and a second internal surface having a plurality of second internal rakes, and wherein the first and second internal rakes progressively get closer to the rotatable tool from a first one of the plurality of first internal rakes to a last one of the plurality of second internal rakes.

16. The apparatus as recited in claim 15, wherein the first one of the plurality of first internal rakes is positioned near an inlet of the chamber, and wherein the last one of the plurality of second internal rakes is positioned near an outlet of the chamber.

17. A mulching chamber comprising at least one internal surface, and a plurality of internal rakes configured in a non-linear arrangement along the at least one internal surface and configured to create mulch from feed material.

18. A land preparation machine, comprising:
a vehicle;
a land preparation apparatus connectable to the vehicle, comprising
a housing,
a chamber formed within the housing, and
first and second internal surfaces formed within the chamber, wherein
the first surface is near an inlet for feed material,
the second surface is near an outlet of the chamber, and
the second surface is positioned such that it receives feed material after it passed along the first surface; and
a plurality of internal rakes extending from the first and second internal surfaces and configured in a non-linear arrangement relative to a longitudinal axis of the land preparation apparatus.

19. The land preparation machine recited in claim 18, wherein the plurality of internal rakes are arranged in an inwardly tapering or funneling arrangement relative to the longitudinal axis.

20. The land preparation machine recited in claim 18, wherein the plurality of internal rakes are arranged in an outwardly tapering or reverse funneling arrangement relative to the longitudinal axis.
